(19) United States
(12) Patent Application Publication
(10) Pub. No.: US 2008/0169731 A1
(43) Pub. Date: Jul. 17, 2008

(54) ROTOR FOR HYBRID STEP MOTOR WITH SMOOTH MOTION

(76) Inventors: Ted T. Lin, Saratoga, CA (US); Ryan C. Lin, Cupertino, CA (US)

Correspondence Address: SCHNECK & SCHNECK, P.O. BOX 2-E, SAN JOSE, CA, 95109-0005, US

(21) Appl. No.: 11/622,327

(22) Filed: Jan. 11, 2007

(51) Int. Cl. H02K 37/14; H02K 37/12

(52) U.S. Cl. 310/49 R

(57) ABSTRACT

A hybrid step motor creates additional detent positions between successive drive phases of the motor for smooth motion and micro-step accuracy. A multi-section rotor has two sets of rotor sections that are displaced by the standard one-half rotor tooth pitch plus-or-minus an additional displacement angle equal to one-quarter of the fundamental step angle. The motor can also employ a stator in which two groups of teeth on the stator poles are displaced from the standard stator tooth pitch by an amount selected to create even more detent positions.

### TECHNICAL FIELD

The invention related generally to electric motor structures designed to rotate step by step, i.e., the rotor is specially adapted for smooth motion and accurate microstepping.

### BACKGROUND ART

Step motors are used in a wide variety of applications that require precise motion control, such as printers, scanners, x-y tables, turntables, tape and disk drive systems, security cameras and other optical equipment, robotics, CNC (computer-numeric-control) machines tools, dispensers, and injector pumps. A wide variety of step motor designs have been introduced in order to achieve specific performance goals, such as reduced noise and vibration, increased resolution and accuracy of motor positions, adequate holding torque, and efficient power usage over a range of motor speeds. These different performance factors are net in a variety of ways to be the step motor designs, often involving tradeoffs or compromises.

A step motor is characterized by stable detent positions where rotor and stator teeth are at maximum alignment. When full current is applied in a specified sequence to distinct sets of coils (wound around poles of the stator in most designs), the step motor moves in discrete rotational steps from one detent position to the next. Alternatively, a microstepping mode of driving the step motor divides a full step into as many as 500 micro-steps, by applying approximately sinusoidal current waveforms to the coils, instead of simply 100% on/off. The unequal pull of partially energized coils causes the motor to assume intermediate positions between the full-step detent positions. Microstepping, not only increases the motor's position resolution, but also improves the smoothness of motion for quieter operation and reduced vibration over other drive modes.

The stable detent positions corresponds to the one-phase ON drive state in which full current is applied to tone group of coils and zero current is applied to the other groups of coils. Due to the stable nature of a detent position, where rotor and stator teeth are in maximum alignment, the rotor has difficulty pulling out of the detent position. When microstepping, this problem may manifest as erratic motion with a consequent loss of micro-step accuracy in the vicinity of a detent. Note that, unlike the full-step detent positions, the micro-steps are not guaranteed to be equal in size, but can depend on any of a number of factors, including pole geometry, coil inductance, and detent torque.

Mechanical damping has been used to smooth a step motor's motion, but also adds load to the motor and cannot improve step accuracy. Electromagnetic damping, through the use of auxiliary damping windings to absorb or provide energy to the phase windings by mutual induction, has effects similar to that of mechanical damping.

Another basic approach suppresses torque harmonics by breaking various rotational symmetries in the motor geometry, e.g., by displacing the positions of one or more groups of stator poles or modifying their relative dimensions, or by varying the pitch, positioning or widths of different groupings of stator teeth. This technique can effectively average the magnetic field's influence on torque.

U.S. Pat. No. 4,739,021 to Brigham et al. describes a motor having respective first and second rotor/stator combinations arranged so that the harmonic produces by one cancels the harmonic produced by the other. In particular, this may be achieved by displacing a first set of rotor teeth from a second set of rotor teeth (or alternatively, by displacing a first set of stator pole teeth or stator poles from a second set of stator pole teeth or poles). The displacement angle in electrical degrees is αₑ=180°/h, where h is an integer defining the torque harmonic to be attenuated. The corresponding mechanical displacement angle between the respective rotor (or stator) sets is specified as being αₘ=αₑ/p, where p is the number of rotor teeth. These formulae yield particular displacements that depend upon the choice of torque harmonic to be suppressed.

### SUMMARY DISCLOSURE

The present invention is a hybrid step motor in which two groups of rotor sections are displaced from one another by an amount selected to create extra detent positions within the fundamental full step positions. In particular, the displacement is specified as one-half rotor tooth pitch plus-or-minus one-quarter of the motor's fundamental step angle. This particular displacement minimized the rotor and stator teeth lineup at any one motor position, multiplying the number of detent positions and allowing the rotor to pass through the natural detent positions more smoothly and less erratically. As a result, micro-step accuracy is greatly improved.

The changes provided to the rotor can also be combined with a variety of known stator designs that also contribute to reducing torque variability, harmonic vibrations and the like. Thus, the stator design could have two or more groups of stator teeth on the stator poles with positions offset relative to one another by an amount that also introduces un-energized detent positions of its own, as described in this inventor's pending U.S. application Ser. No. 11/425,819 filed on Jun. 22, 2006, and incorporated by reference herein. That stator design doubles the number of detent positions, and in combination with the rotor in the present invention we can effectively quadruple the number of detent positions for each fundamental step angle.

### BRIEF DESCRIPTION OF THE DRAWINGS

FIGS. 1A and 1B are respective plan and enlarged cutout views of an exemplary step motor in accord with the present invention. FIG. 1B also illustrates one exemplary embodiment of a stator design that can be used in combination with the improved rotor in the present invention.

FIG. 2 is a side view of an exemplary rotor in accord with the present invention for use in a hybrid step motor as in FIGS. 1A and 1B.

FIG. 3 is a graph of detent torque versus step angle comparing a conventional step motor, one with the exemplary stator design alone, and one combining the improved rotor of the present invention with the exemplary stator.

### DETAILED DESCRIPTION

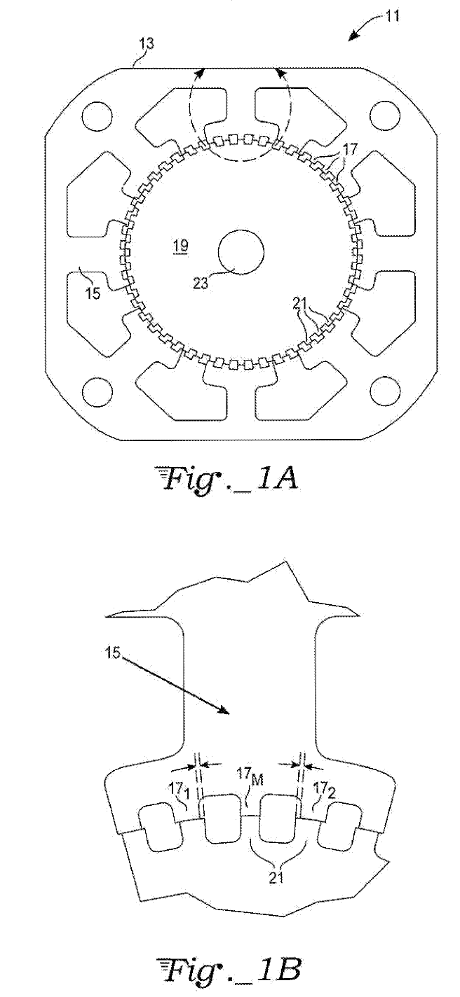

With reference to FIG. 1A, a hybrid step motor 11 in accord with the present invention includes a stator 13 having a plurality of stator poles 15 with a plurality of stator teeth 17 on each of the poles. As is well known, the stator poles 15 are wound with stator coils (not shown for simplicity) that can be driven in a series of phases so as to magnetically interact with teeth 21 of a rotor 19. Any design may be used for the stator, its windings and drive circuitry. The drive mode can be either bipolar (current flow through the coils allowed in both directions) or unipolar (current flow in only one direction through the coils), as desired. Likewise, the drive current applied to the coils can either be full on/off (approximately square waveform) for full-step or half-step operation, or approximately sinusoidal for a microstepping operation. Advantages of the present invention are especially apparent when using the microstepping drive mode, in that micro-step accuracy is greatly improved by the smoother motion through the motor's detent position.

One preferred stator design for use in the present invention is that described in pending U.S. application Ser. No. 11/425,819. The stator has the teeth on the stator poles organized into several distinct groups with special pitch angles for each group selected to avoid teeth alignment at any one-phase ON or two-phase ON stable detent positions. The standard pitch for all groups of stator teeth is Pₛ=2×θ×P, where θ is the fundamental full-step angle and P is the number of bipolar phases of the motor. For an even number of teeth per stator pole, the teeth are divided into two groups that are separated from each other by a special pitch angle Pₑ=Pₛ±θ/2. For an odd number of teeth per stator pole, as seen in the exemplary cut-away close up in FIG. 1B, the teeth are divided into three groups 17₁, 17_{M} and 17₂, wherein the teeth of the two end groups 17₁ and 17₂ are separated from those of the middle group 17_{M} by a special pitch angle Pₒ=Pₛ±θ/4. As noted above, the overall effect of the stator tooth positioning for this stator construction is to create an additional detent position between each of the prior phases, thereby doubling the number of detent positions and detent torque by half. Moreover, the detent positions are not in line with the one-phase ON and two-phase ON positions, so the motor will more easily pass through the natural detent positions, providing smooth motion and better micro-step accuracy. Combined with the improved rotor described in detail below, the overall step motor has greatly improved accuracy.

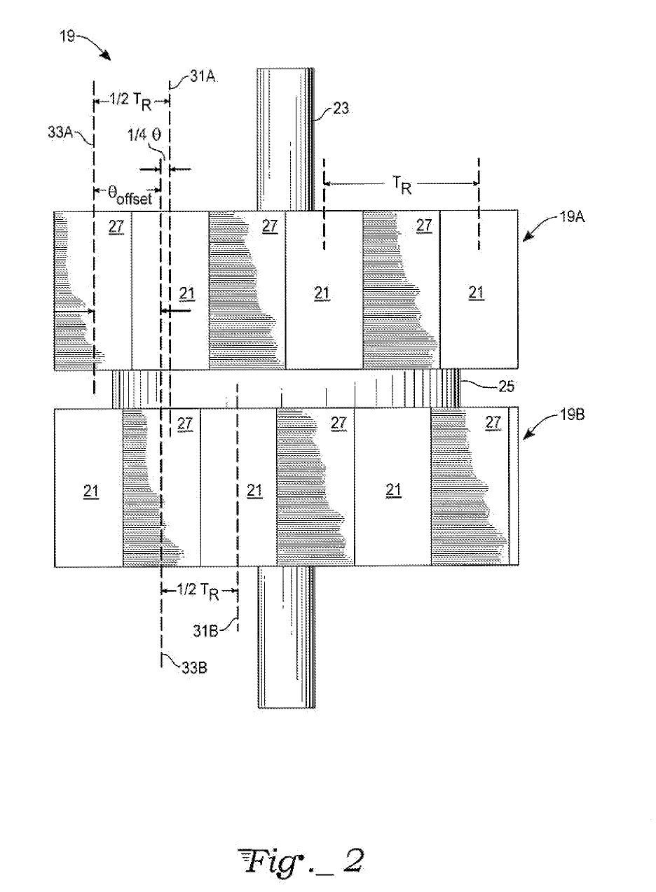

Referring again to FIG. 1, and also to FIG. 2, the rotor 19, for use in the hybrid step motor of the present invention, is a multi-section rotor including at least one first rotor section 19A and least one second rotor section 19B axially displaced from the first rotor section 19A. Both rotor sections 19A and 19B are mounted on shaft 23 with a permanent magnet 25 sandwiched between the rotor sections. While the exemplary rotor shown in FIG. 2 has only two sections 19A and 19B, alternative constructions may have more than two rotor sections laid out along the rotor shaft 23 with permanent magnets 25 between adjacent sections, where the plurality of rotor sections may belong to either of two alternating sets corresponding to the two rotor sections 19A and 19B shown here. Each of the rotor sections 19A and 19B has a plurality of equally spaced rotor teeth 21 for a constant rotor tooth pitch, with valleys 27 between adjacent teeth. The rotor teeth 21 need not necessarily, and often will not, have the same width as the corresponding stator teeth 17. Also, the teeth 21 for one rotor section 19A need not have the same width as the teeth 21 for another rotor sections 19B. Indeed, the relation between the rotor and stator teeth widths, and between rotor teeth widths for different rotor sections, can be optimized for a desired torque profile under various drive conditions.

The present invention relates particularly to the placement of the rotor teeth relative to the two sets of rotor sections 19A and 19B. In FIG. 2, the rotor tooth pitch is τᵣ. One-half tooth pitch corresponds to the center-to-center distance between tooth and valley in any in rotor section, as seen by the distance between center lines 31A and 33A (or between center lines 31B and 33B) in FIG. 2. Also, as seen in FIG. 2, the offset θ_{offset} between rotor sections 19A and 19B is close to one-half tooth pitch (teeth in one rotor section nearly align with valleys in the other rotor section), but with an additional displacement angle ¾·θ.

In a conventional design, the rotor for a hybrid step motor has the first and second rotor sections offset by one-half tooth pitch. Particular rotor teeth and particularly stator teeth are aligned once for each phase. This is the natural detent position of a step motor. The two sections of the rotor contribute the detent torque. Within a single rotor pitch angle, there are 4 detent positions in a conventional 2-phase bipolar motor (or 4-phase unipolar motor); 6 detent positions in a 3-phase bipolar motor (or 6-phase unipolar motor); and 10 detent positions in a 5-phase bipolar motor (or 10-phase unipolar motor). The aforementioned stator design of U.S. patent application Ser. No. 11/425,819, as exemplified by the embodiment shown in FIG. 1A, doubles the number of detent positions. The new rotor of the present invention, again doubles the number of detent positions. In combination, the afore-described stator and the new rotor quadruple the number of detent positions over that of conventional designs, so that, for example, a 2-phase bipolar motor will have 16 detent positions within a single rotor pitch angle.

In order to determine the proper displacement of rotor teeth 21 in the different rotor sections 19A and 19B for a given motor type (bipolar or unipolar; number of motor drive phases), let us first define the various detent positions that should be generated. We will use a two-phase bipolar motor (or four-phase unipolar motor) with the afore-described stator construction as out example. A first detent position will occur as the teeth of the first rotor section 19A align with group 1 stator teeth 17₁ on drive phase A. If the other rotor section 19B is displaced by 1/16 pitch from the standard hybrid rotor offset of ½ pitch, the second detent will be generated as the second rotor section 19B aligns with the group 1 stator teeth 17₁ on phase A after the rotor has mover 1/16 of the pitch angle. The third detent position will be generated as the first rotor section 19A aligns with the group 2 stator teeth 17₂ on phase A after the rotor has moved yet another 1/16 of the pitch, i.e. ⅛ pitch from its original position. The fourth detent position will be generated as the second rotor section 19B aligns with the group 2 stator teeth 17₂ on phase A when the cumulative rotor motion is 3/16 of the pitch angle. The fifth through eighth detents will be generated from phase B while the rotor is in positions of 4/16 to 7/16 of the pitch angle. The ninth through sixteenth detents are generated from a repeat of phases A and B (alternatively, phases C and D in unipolar motors) while the rotor is in positions 8/16 through 15/16 of the pitch angle. Thus, with a rotor displacement of 1/16 pitch from the standard ½ pitch offset, a total of 16 detent positions are generated within a single rotor pitch movement.

Extending this concept to other motor types, a three-phase bipolar (or six-phase unipolar motor) will require a displacement of 1/24 of the rotor pitch from the standard ½ pitch offset, and a five-phase bipolar (or ten-phase unipolar motor) will require a displacement of 1/40 of the rotor pitch from the standard offset in order to obtain the extra detent positions. The displacement can occur in either direction relative to the standard offset, for total offsets of 7/16 or 9/16 of a pitch for two-phase bipolar motors, 11/24 or 13/24 of a pitch for three-phase bipolar motors, 19/40 or 21/40 of a pitch for five-phase bipolar motors, and like offers for four, six, and ten-phase unipolar motors.

A fundamental full-step angle is 1/44, ⅙ and 1/10 of a rotor tooth pitch for respective 2-, 3- and 5-phase bipolar motors, and like unipolar motors. Thus, the offset can be generalized as being the standard offset of ½ rotor tooth pitch, plus-or-minus a displacement of ¼ of the fundamental full-step angle. In terms of the number of rotor teeth T on each rotor section 17A or 17B, the constant rotor tooth pitch is τᵣ=360°/T. The fundamental full step angle of the motor is θ=τᵣ/2P, where P is the number of bipolar phases (or half the number of unipolar phases) of the motor. Thus, the combined offset angle between the first and second rotor sections 17A and 17B is θ_{offset}=½·τᵣ±¼·θ=(360°/2T)±(360°/8·T·P).

### EXAMPLES

### Number of Rotor Teeth T=50 (Rotor Tooth Pitch=7.2°):

For a two-phase bipolar (four-phase unipolar) motor (P=2), the fundamental full-step angle is 1.8°. The offset angle θ_{offset}=3.6°±0.45°=3.15° or 4.05°.

For a three-phase bipolar (six-phase unipolar) motor (P=3), the fundamental full-step angle is 1.2°. The offset angle θ_{offset}=3.6°±0.30°=3.30° or 3.9°.

For a five-phase bipolar (ten-phase unipolar) motor (P=5), the fundamental full-step angle is 0.72°. The offset angle θ_{offset}=3.6°±0.18°=3.42° or 3.78°.

Note that the corresponding mechanical displacement angles αₘ for suppressing torque harmonics, as taught by Brigham in U.S. Pat. No. 4,739,201, are 3.6° for suppressing the fundamental (h=1), 1.8° for suppressing the second harmonic (h=2), 1.2° for suppressing the third harmonic (h=3), etc. These values αₘ for suppressing harmonics differ substantially from either the displacement angle ¼·θ for offset angle θ_{offset} for the rotor sections of the present invention needed to create extra detent positions between the full-step positions.

### Number of Rotor Teeth T=100 (Rotor Tooth Pitch=3.6°):

For a two-phase bipolar (four-phase unipolar) motor (P=2), the fundamental full-step angle is 0.9°. The offset angle θ_{offset}=1.8°±0.225°=1.575° or 2.025°.

For a three-phase bipolar (six-phase unipolar) motor (P=3), the fundamental full-step angle is 0.6°. The offset angle θ_{offset}=1.8°±0.15°=1.65° or 1.95°.

For a five-phase bipolar (ten-phase unipolar) motor (P=5), the fundamental full-step angle is 0.36°. The offset angle θ_{offset}=1.8°±0.09°=1.71° or 1.89°.

Likewise these offset values differ substantially from those used in prior motors to suppress torque harmonics.

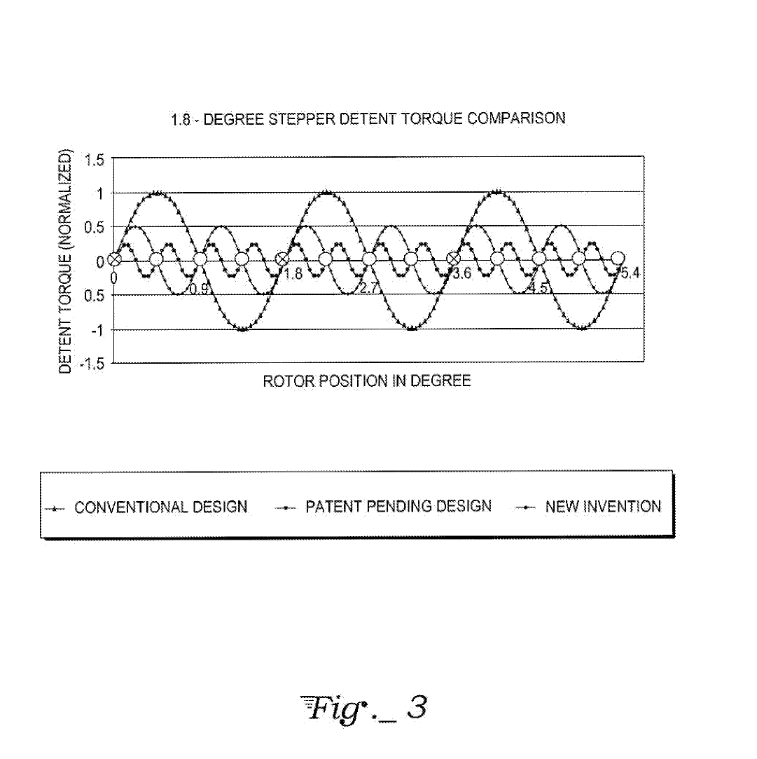

FIG. 3 shows a comparison of the torque profiles between a hybrid step motor of conventional design with standard rotor and stator, a hybrid step motor constructed with an improved stator design according to this inventor's pending U.S. application Ser. No. 11/425,819, and a motor constructed with a rotor constructed in accord with the present invention and also using the improved stator. The graph corresponds to a 1.8° motor, and the detent torque is normalized with peak torque for the conventional motor being 1. This shows the extra detent positions added by both the improved stator and the new rotor in the present invention. Also, the detent torque amplitude is halved and quartered by the respective improvements over the conventional design as the number of detents is doubled and quadrupled. The amount of tooth line-up contributing to torque is reduced at any given position, so that the rotor passes through the detent positions smoothly without sacrificing micro-step accuracy.

What is claimed is:

1. A hybrid step motor, comprising:
a stator having a plurality of stator poles with a plurality of rotationaly displaced stator teeth on said poles; and
a multi-section rotor including at least one first rotor section and at least one second rotor section axially displaced from the first rotor section with a permanent magnet between the rotor sections providing an axially-aligned magnetic field, both first and second rotor sections having plurality of rotationally displaced rotor teeth in magnetic coupling relation to the stator teeth, the rotor teeth in each section having a constant rotor tooth pitch,
wherein the rotor teeth of the first rotor section are rotationally displaced relative to the rotor teeth of the second rotor section by an offset angle selected to create extra detent positions between successive drive phases of the motor, the offset angle being one-half of the rotor tooth pitch plus-or-minus one-quarter of a fundamental full step angle of the motor.

2. The hybrid step motor as in claim 1, wherein the constant rotor tooth pitch is τᵣ=360°/T, where T is the number of rotor teeth on each rotor section, and wherein the fundamental full step angle of the motor is θ=τᵣ/2P, where P is the number of bipolar phases of the motor, so that the offset angle between the first and second rotor sections is θ_{offset}=½·τᵣ±¼·θ=(360°/2T)±(360°/8·T·P).

3. The hybrid step motor as in claim 2, wherein the number of rotor teeth T in each rotor section is in a range from 50 to 100.

4. The hybrid step motor as in claim 2 operated as a two-phase bipolar motor (P=2) and a displacement angle contribution ¼·θ to the offset angle θ_{offset} is 1/16 of the rotor tooth pitch.

5. The hybrid step motor as in claim 2 operated as a three-phase bipolar motor (P=3) and a displacement angle contribution ¼·θ to the offset angle θ_{offset} is 1/24 of the rotor tooth pitch.

6. The hybrid step motor as in claim 2 operated as a five-phase bipolar motor (P=53) and a displacement angle contribution ¼·θ to the offset angle θ_{offset} is 1/40 of the rotor tooth pitch.

7. The hybrid step motor as in claim 2 operated as a unipolar motor, wherein P is half the number of unipolar phases.

8. The hybrid step motor as in claim 2, wherein each stator pole has a specified number of stator teeth thereon that organized into at least two groups of stator teeth, with a standard stator tooth pitch Pₛ=2×θ×P, and with the two groups of stator teeth displaced relative to one another by a specified stator group offset selected to introduced additional un-energized detent positions between the successive drive phases of the motor.

9. The hybrid step motor as in claim 8, wherein the number of stator teeth on each stator pole is odd, with first and second end groups of stator teeth being displaced relative to a middle group of stator teeth by a stator group offset Pₒ=Pₛ±θ/4.

10. The hybrid step motor as in claim 8, wherein the number of stator teeth on each stator pole is even, with first and second groups of stator teeth being displaced relative to each other by a stator group offset Pₑ=Pₛ±θ/2.
